(19) United States
(12) Patent Application Publication
(10) Pub. No.: US 2026/0100726 A1
(43) Pub. Date: Apr. 9, 2026

(54) WALKIE-TALKIE WITH STABLE PERFORMANCE

(71) Applicant: MEI JIANG, Shenzhen (CN)

(72) Inventor: MEI JIANG, Shenzhen (CN)

(21) Appl. No.: 18/920,972

(22) Filed: Oct. 20, 2024

(30) Foreign Application Priority Data
Oct. 8, 2024 (CN) 202422417358.6

(51) Int. Cl. H04B 1/3827

(52) U.S. Cl. CPC H04B 1/3833

(57) ABSTRACT

A circuit board assembly and a signal antenna electrically connected to the circuit board assembly are disposed in a housing. The signal antenna is the shape of a helical spring. The signal antenna is suspended in the housing. The signal antenna is hidden and disposed in the housing, and is designed to be placed in a suspended position in the shape of a cylindrical helical compression spring. The signal antenna forms a non-rigid connection with the body of the walkie-talkie through a movable terminal and elastic characteristics, which not only can effectively resolve the damage caused by an external impact to the signal antenna but also effectively protects the use quality and service life of the walkie talkie. Further, the signal antenna in the shape of the cylindrical helical compression spring can enhance the signal grabbing ability and the stability of signal transmission.

### CROSS REFERENCE TO RELATED APPLICATIONS

The present application claims the priority of Chinese patent application No. 202422417358.6, filed on Oct. 8, 2024, and contents of which are incorporated herein by reference.

### TECHNICAL FIELD

This utility model relates to the technical field of a walkie-talkie, and specifically to a walkie-talkie with a stable performance.

### TECHNICAL BACKGROUND

An antenna is a converter which transforms a guided wave propagating on a transmission line into an electromagnetic wave propagating in an unbounded medium (usually a free space), or performs the opposite transformation. The antenna is a component used in radio equipment to transmit or receive an electromagnetic wave. A radio communication, a broadcast, a television, radar, navigation, electronic countermeasure, remote sensing, radioastron and other engineering systems that utilize electromagnetic waves to transmit information rely on the antenna.

A walkie-talkie is one of applications of the antenna. The most important part of the walkie-talkie is the antenna. The antenna of the walkie-talkie in the prior art is mostly in a leaky manner. When the walkie-talkie is not in use or is in a transportation process, the antenna breaks often, thus affecting the use of the walkie-talkie.

### SUMMARY

An objective of the utility model is to provide a walkie-talkie with a stable performance. A signal antenna is hidden and disposed in a housing, and is designed to be placed in a suspended position in the shape of a cylindrical helical compression spring. The signal antenna forms a non-rigid connection with the body of the walkie-talkie through a movable terminal and elastic characteristics, which not only can effectively resolve the damage caused by an external impact to the signal antenna but also can enhance the signal grabbing ability and the stability of signal transmission, achieves the effect of clear and high fidelity of intercom contents, and effectively solves the problems proposed in the technical background.

To realize the above objective, the utility model provides the following technical solution: A walkie-talkie with a stable performance includes a housing. A circuit board assembly is disposed in the housing. The circuit board assembly is electrically connected to a signal antenna. The signal antenna is in the shape of a helical spring. The signal antenna has a fixed terminal at one end and a movable terminal at the other end. The fixed terminal is fixedly connected to the housing or the circuit board assembly. The signal antenna is suspended in the housing. The housing is located at least in the circumferential portion of the signal antenna. The housing is disposed as a non-electromagnetic shielding housing.

Preferably, the fixed terminal of the signal antenna is welded to the circuit board assembly and fixedly connected to the circuit board assembly. The signal antenna is in the shape of a cylindrical helical compression spring.

Preferably, the movable terminal of the signal antenna is connected against the inner wall surface of the housing.

Preferable, the housing is in the shape of a toy car. The housing includes an upper housing and a lower housing covered and connected integrally. A wheel assembly is disposed at the bottom of the housing. A driving mechanism is disposed in the housing. The driving mechanism is configured to drive the wheel assembly to move. The driving mechanism is electrically connected to a circuit board assembly.

Preferably, the driving mechanism includes a driving motor, a worm disposed on an output shaft of the driving motor, and a gear fixedly connected to a rotating shaft of the wheel assembly. The driving motor drives the worm to rotate. The worm is meshed, transmitted and connected to the gear.

Preferably, a battery and a loudspeaker are disposed in the housing. The battery and the loudspeaker are electrically connected to a circuit board assembly. The loudspeaker is disposed in close proximity to the inner wall of the housing. The housing is provided with a sound-transmitting hole passing through the housing corresponding to a location of the loudspeaker.

Preferably, the circuit board assembly is electrically connected to a control button and a USB interface. The control button and the USB interface are both disposed in a through hole preset in the housing and extend outwardly from the through hole.

Preferably, the housing is embedded with a modeling panel. The modeling panel is circumferentially disposed around the control button.

Compared with the prior art, this application has the following beneficial effects:

For the utility model, the signal antenna is hidden and disposed in the housing, and is designed to be placed in a suspended position in the shape of a cylindrical helical compression spring. The signal antenna forms a non-rigid connection with the body of the walkie-talkie through the movable terminal and elastic characteristics, which not only can effectively resolve the damage caused by an external impact to the signal antenna but also effectively protects the use quality and service life of the walkie talkie. Further, the signal antenna in the shape of the cylindrical helical compression spring can enhance the signal grabbing ability and the stability of the signal transmission. Further, the signal antenna and the circuit board assembly are directly welded and communicated with each other but are not transferred through other docking mechanisms, which transmits the signal more smoothly, achieves the effect of clear and high fidelity of intercom contents, and effectively optimizes the defects of a traditional walkie talkie.

### BRIEF DESCRIPTION OF THE DRAWINGS

FIG. 1 shows an exploded view of a structure of the utility model;

FIG. 2 shows a schematic diagram of the way in which a circuit board assembly of the utility model is connected to a receiving antenna;

FIG. 3 shows a three-dimensional diagram of the appearance of the utility model.

In the figures: 1 upper housing; 11 sound-transmitting hole; 12 modeling panel; 2 circuit board assembly; 21 control button; 22 USB interface; 3 signal antenna; 4 loudspeaker; 5 battery; 6 wheel assembly; 7 driving motor; 71 worm; 72 gear; 8 lower housing.

### DETAILED DESCRIPTION OF EMBODIMENTS

The following clearly and completely describe the technical solutions in an embodiment of the utility model in conjunction with the accompanying drawings in the embodiment of the utility model. Obviously, the described embodiment is only a part of the embodiments of the present invention, rather than all embodiments. Based on the embodiments of the utility model, all other embodiments obtained by a person skilled in the art without creative work shall fall within the protection scope of the present invention.

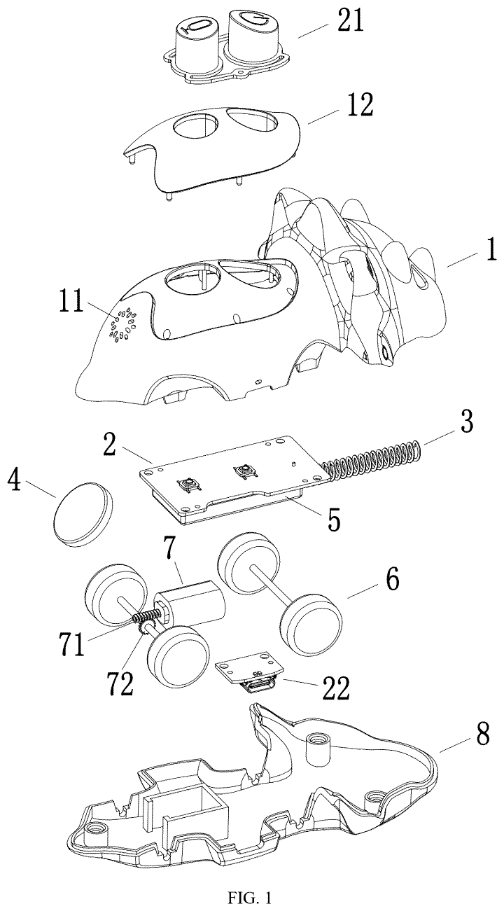

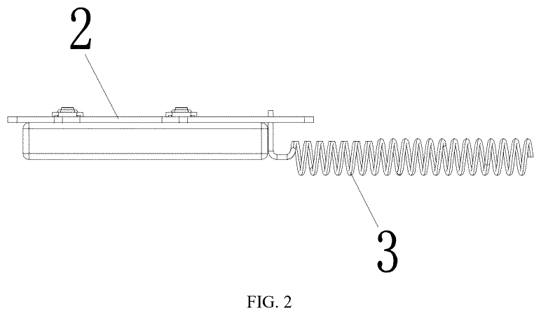

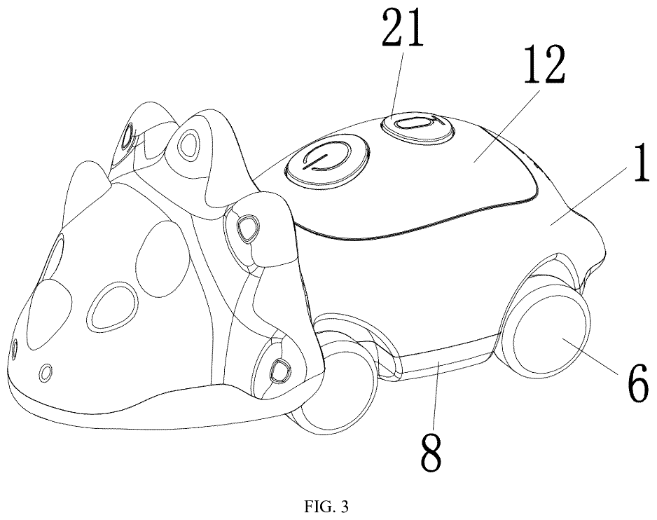

Referring to FIGS. 1-3, a walkie-talkie with a stable performance includes a housing. The housing is in the shape of a toy car. The housing includes an upper housing 1 and a lower housing 8 covered and connected integrally. The housing is provided with a circuit board assembly 2. A wheel assembly 6 is disposed at the bottom of the housing. The housing is provided with a driving mechanism. The driving mechanism is configured to drive the wheel assembly 6 to move. The driving mechanism is electrically connected to the circuit board assembly 2. The circuit board assembly 2 is electrically connected to the signal antenna 3. The signal antenna 3 is in the shape of a cylindrical helical compression spring. The signal antenna 3 has a fixed terminal at one end and a movable terminal at the other end. The fixed terminal of the signal antenna 3 is welded to the circuit board assembly 2 and fixedly connected to the circuit board assembly 2. The signal antenna 3 is integrally welded to the circuit board assembly 2 so that a signal is transmitted more smoothly, which overcomes the defects of information discontinuity caused by a signal antenna of a traditional walkie-talkie through copper butt connection. The signal antenna 3 is suspended in the housing. The movable terminal is connected against the inner wall surface of the housing. Under normal circumstances, the movable terminal is elastically against the inner wall of the housing so that the signal antenna 3 is stably suspended in the fixed orientation in the housing. In the process of use, the signal antenna 3 is not substantially deviated or aligned, which protects the stability of the use of a product. If a large impact occurs, for example, the walkie-talkie falls from a high place and other phenomena occur, when an external impact is large enough so that the signal antenna 3 overcomes its own elastic characteristics to produce deformation, a free end of the signal antenna 3 is detached from the inner wall of the housing while being deformed. Therefore, the signal antenna 3 and the body of the walkie-talkie form a non-rigid connection. This means that an external impact to the walkie-talkie body does not produce excessive instantaneous momentum on the signal antenna 3, thereby improving the reliability and stability of the signal antenna 3. When the external impact is lifted, the signal antenna 3 can be automatically reset to an initial form under the action of its own elastic characteristics. The signal antenna is in the shape of a cylindrical helical compression spring, which, on the one hand, contributes to elastically resetting when the external impact occurs. On the other hand, a cylindrical spiral structure with the same cross-section size and the same spacing size can enhance the signal grabbing ability and the stability of the signal transmission, and reduce the interference of larger variable factors in an operation process. The housing is located at least in the circumferential portion of the signal antenna 3. The housing is disposed to be a non-electromagnetic shielding housing, for example, a housing made of ABS material can be used.

The driving mechanism includes a driving motor 7, a worm 71 disposed on an output shaft of the driving motor 7, a gear 72 fixedly connected to a rotating shaft of the wheel assembly 6. The driving motor 7 drives the worm 71 to rotate. The worm 71 is meshed, transmitted and connected to the gear 72. When an output shaft of the driving motor 7 is rotated, the worm 71 rotates axially and then is meshed with the gear 72 for transmission to rotate the wheel assembly 6, thereby driving a toy car styled walkie-talkie to run.

A battery 5 and a loudspeaker 4 are disposed in the housing. The battery 5 and the loudspeaker 4 are electrically connected to the circuit board assembly 2. The loudspeaker 4 is disposed in close proximity to the inner wall of the housing. The housing is provided with a sound-transmitting hole 11 passing through the housing corresponding to the location of the loudspeaker 4. The circuit board assembly 2 is electrically connected to a control button 21 and a USB interface 22. The control button 21 and the USB interface 22 are both disposed in a through hole preset in the housing and extend outwardly from the through hole. The control button 21 is configured to control the opening and closing of the drive mechanism and adjust the intercom mode of the walkie-talkie. When the USB interface 22 is connected to an external power supply using a charging wire, it is able to charge the battery 5 to replenish electrical energy.

The housing is embedded with a modeling panel 12. The modeling panel 12 is disposed circumferentially around the control buttons 21. The modeling panel 12 is configured to beautify the appearance of the walkie-talkie and plays a decorative role.

In a word: for the utility model, the signal antenna 3 is hidden and disposed in the housing, and is designed to be placed in a suspended position in the shape of a cylindrical helical compression spring. The signal antenna forms a non-rigid connection with the body of the walkie-talkie through the movable terminal and elastic characteristics, which not only can effectively resolve the damage caused by the external impact to the signal antenna but also effectively protects the use quality and service life of the walkie talkie. Further, the signal antenna in the shape of the cylindrical helical compression spring can enhance the signal grabbing ability and the stability of the signal transmission. Further, the signal antenna 3 and the circuit board assembly 2 are directly welded and communicated with each other but are not transferred through other docking mechanisms, which transmits the signal more smoothly, achieves the effect of clear and high fidelity of intercom contents, and effectively optimizes the defects of a traditional walkie talkie.

It should be noted that relational terms herein such as a first and a second are only used to distinguish one entity or operation from another entity or operation, and do not necessarily require or imply any such an actual relationship or an order between these entities or operations. Moreover, the terms “include”, “comprise” or any other variants thereof are intended to cover non-exclusive inclusion, so that a process, a method, an article or a device including a series of elements not only include those elements, but also include other elements that are not explicitly listed, or also include elements inherent to this process, method, article or device.

Although the embodiments of the utility model have been shown and described, those skilled in the art can understand that various changes, modifications, substitutions and variants can be made to these embodiments without departing from the principle and spirit of the utility model. The scope of the utility model is defined by the appended claims and their equivalents.

The utility model discloses a walkie talkie with a stable performance. A circuit board assembly and a signal antenna electrically connected to the circuit board assembly are disposed in a housing. The signal antenna is the shape of a helical spring. The signal antenna is suspended in the housing. The signal antenna is hidden and disposed in the housing, and is designed to be placed in a suspended position in the shape of a cylindrical helical compression spring. The signal antenna forms a non-rigid connection with the body of the walkie-talkie through a movable terminal and elastic characteristics, which not only can effectively resolve the damage caused by an external impact to the signal antenna but also effectively protects the use quality and service life of the walkie talkie. Further, the signal antenna in the shape of the cylindrical helical compression spring can enhance the signal grabbing ability and the stability of signal transmission. Further, the signal antenna and the circuit board assembly are directly welded and communicated with each other but are not transferred through other docking mechanisms, which transmits a signal more smoothly, achieves the effect of clear and high fidelity of intercom contents, and effectively optimizes the defects of a traditional walkie-talkie.

What is claimed is:

1. A walkie-talkie with a stable performance, comprising a housing, characterized in that a circuit board assembly (2) is disposed in the housing, the circuit board assembly (2) is electrically connected to a signal antenna (3), the signal antenna (3) is in a shape of a helical spring, the signal antenna (3) has a fixed terminal at one end and a movable terminal at the other end, the fixed terminal is fixedly connected to the housing or the circuit board assembly (2), the signal antenna (3) is suspended in the housing, the housing is located at least in a circumferential portion of the signal antenna (3), and the housing is disposed as a non-electromagnetic shielding housing.

2. The walkie-talkie with the stable performance according to claim 1, characterized in that the fixed terminal of the signal antenna (3) is welded to the circuit board assembly (2) and fixedly connected to the circuit board assembly (2), and the signal antenna (3) is in a shape of a cylindrical helical compression spring.

3. The walkie-talkie with the stable performance according to claim 1, characterized in that the movable terminal of the signal antenna (3) is connected against an inner wall surface of the housing.

4. The walkie-talkie with the stable performance according to claim 1, characterized in that the housing is in a shape of a toy car, the housing comprises an upper housing (1) and a lower housing (8) covered and connected integrally, a wheel assembly (6) is disposed at a bottom of the housing, a driving mechanism is disposed in the housing, the driving mechanism is configured to drive the wheel assembly (6) to move, and the driving mechanism is electrically connected to the circuit board assembly (2).

5. The walkie-talkie with the stable performance according to claim 4, characterized in that the driving mechanism comprises a driving motor (7), a worm (71) disposed on an output shaft of the driving motor (7), a gear (72) fixedly connected to a rotating shaft of the wheel assembly (6), the driving motor (7) drives the worm (71) to rotate, and the worm (71) is meshed, transmitted and connected to the gear (72).

6. The walkie-talkie with the stable performance according to claim 1, characterized in that a battery (5) and a loudspeaker (4) are disposed in the housing, the battery (5) and the loudspeaker (4) are electrically connected to the circuit board assembly (2), the loudspeaker (4) is disposed in close proximity to an inner wall of the housing, and the housing is provided with a sound-transmitting hole (11) passing through the housing corresponding to a location of the loudspeaker (4).

7. The walkie-talkie with the stable performance according to claim 1, wherein the circuit board assembly (2) is electrically connected to a control button (21) and a USB interface (22), the control button (21) and the USB interface (22) are both disposed in a through hole preset in the housing and extend outwardly from the through hole.

8. The walkie-talkie with the stable performance according to claim 7, wherein the housing is embedded with a modeling panel (12), and the modeling panel (12) is circumferentially disposed around the control button (21).
